(19) United States
(12) Patent Application Publication
(10) Pub. No.: US 2006/0219494 A1
(43) Pub. Date: Oct. 5, 2006

(54) Unidirectional bearing assembly

(75) Inventors: Jung S. Moon, Buffalo Grove, IL (US); Rong Liu, Gurnee, IL (US); Jong Rok Kim, Seoul (KR)

Correspondence Address: GREER, BURNS & CRAIN, 300 S WACKER DR, 25TH FLOOR, CHICAGO, IL, 60606, US

(73) Assignee: IBC-Hearthware, Inc.

(21) Appl. No.: 11/093,591

(22) Filed: Mar. 30, 2005

(51) Int. Cl. F16D 15/00

(52) U.S. Cl. 188/82.1

(57) ABSTRACT

A unidirectional bearing device includes an inner ring, an outer ring concentric with, and spaced from the inner ring, and an annular frame configured to be provided between the inner ring and the outer ring. The frame has a first side including a plurality of sockets for holding a plurality of roller elements, and a second side opposite the first side including a plurality of cavities, each housing a corresponding brake element. The second side also includes a plurality of slots each extending into a corresponding one of the cavities and holding spring elements for maintaining the brake elements in a predetermined position within the cavities. The brake elements and the spring elements cooperatively enable relative rotation between the inner ring and the outer ring in one direction.

### FIELD OF THE INVENTION

The present invention relates to bearings, and in particular, to a bearing assembly which is configured and arranged to rotate in one relative direction.

### BACKGROUND OF THE INVENTION

Many rotating machines such as washing machines, for example, employ a combination clutch/bearing mechanism for driving a rotatable drive shaft. These clutch/bearing mechanisms are often called a one-way clutch, and have a function of transferring torque in one direction and permitting free-wheeling rotation in the other direction. In this manner, when a one-way clutch is connected to a drive source such as a two-way motor, the load connected to the clutch is rotated in only one direction. Some one-way clutches include a cage assembly that holds roller bearings and sprags at various intervals in the circumferential direction. These cages are typically assembled with multiple pieces, and require various methods of holding the assembly together. Often a complicated process is required to assemble the necessary pieces, which contributes to the increased cost of manufacturing.

### SUMMARY OF THE INVENTION

The present invention is directed to a unidirectional bearing device which includes an inner ring, an outer ring concentric with, and spaced from the inner ring, and an annular frame configured to be provided between the inner ring and the outer ring. The frame has a first side including a plurality of sockets for holding a plurality of roller elements, and a second side opposite the first side including a plurality of cavities, each housing a corresponding brake element. The second side also includes a plurality of slots each extending into a corresponding one of the cavities and holding spring elements for maintaining the brake elements in a predetermined position within the cavities. The brake elements and the spring elements cooperatively enable relative rotation between the inner ring and the outer ring in one direction.

### BRIEF DESCRIPTION OF THE DRAWINGS

FIG. 1 is an exploded perspective view of a unidirectional bearing assembly in accordance with one embodiment of the present invention;

FIG. 2 is a plan view of the unidirectional bearing assembly of FIG. 1, with portions cutaway for clarity;

FIG. 3 is a plan view of the opposite side of the bearing assembly of FIG. 2, with portions cutaway for clarity;

FIG. 4 is a plan view of one embodiment of a frame of the present unidirectional bearing assembly, including a plurality of sprags and spring elements;

FIG. 5 is a perspective view of a retaining plate configured to be attached to the frame shown in FIG. 4 for retaining the sprags and the spring elements in the frame;

FIG. 6 is a side elevational side view of the frame shown in FIG. 4, without the sprags and the springs;

FIG. 7 is a sectional view of the bearing assembly along the line 7-7 shown in FIG. 2; and

FIG. 8 is a diagram for illustrating the unidirectional rotation of the bearing assembly of the present invention.

### DETAILED DESCRIPTION OF THE INVENTION

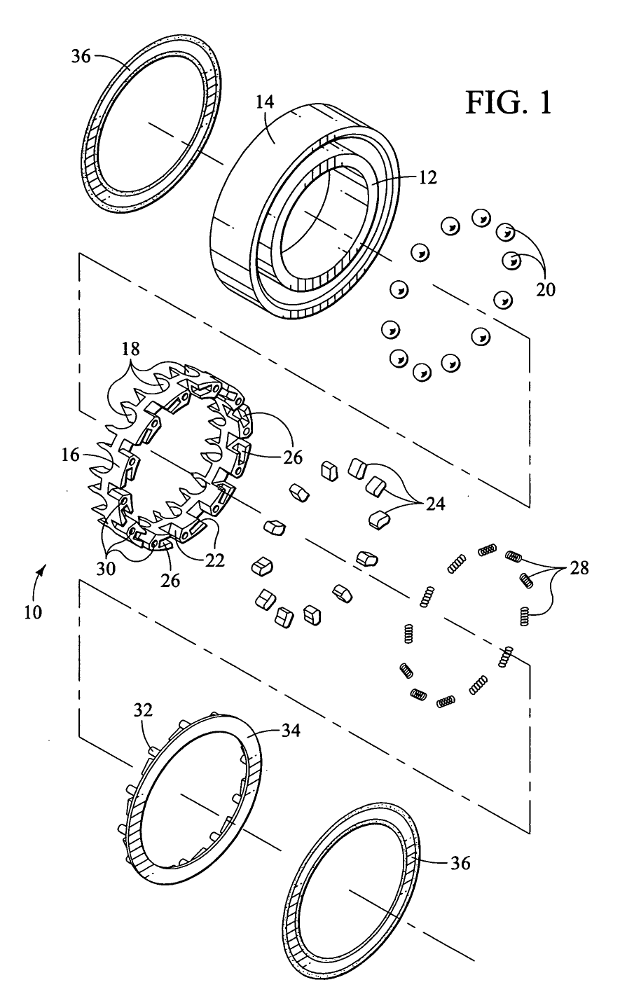

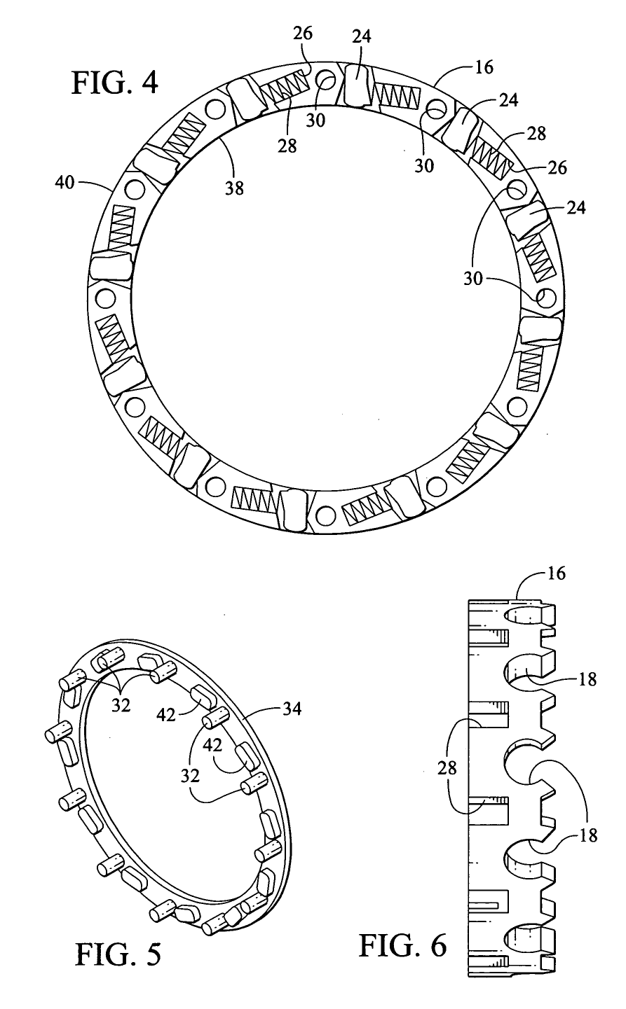

Turning now to FIGS. 1-3, a unidirectional bearing assembly 10 in accordance with one embodiment of the present invention includes an annular inner ring 12 and an annular outer ring 14 concentric with and spaced from the inner ring. An annular frame 16 is configured to be provided in a space between the inner ring 12 and the outer ring 14. The frame 16 includes a plurality of sockets 18 each configured to hold a corresponding roller element 20. A plurality of cavities 22 are formed on the opposite side of the frame 16 from the sockets 18, each of which is configured to receive a wedge or sprag 24. On the same side of the frame 16 as the cavities 22, a number of slots 26 are formed. Each slot 26 extends into a corresponding cavity 22, and is configured to receive a spring element 28. A plurality of holes 30 are also formed on the same side of the frame 16 as the cavities 22 so as to receive a corresponding post 32 protruding from an annular retaining plate 34 (best shown in FIG. 5), which is configured to hold the sprags 24 and the spring elements 28 in their respective cavities 22 and slots 26. A seal plate 36 is provided on each side of the bearing assembly 10.

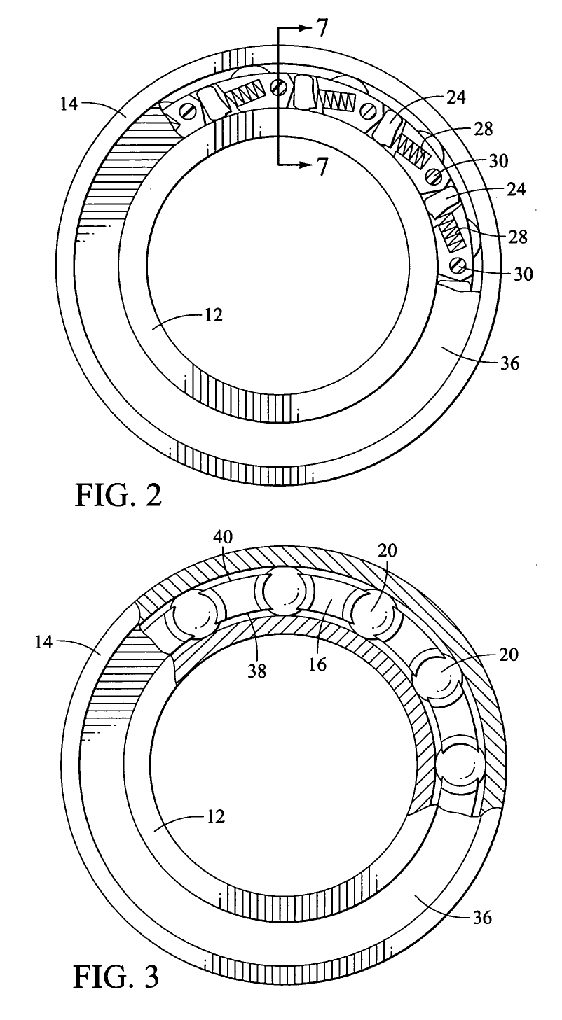

Turning now to FIG. 4, the plurality of cavities-22 are substantially evenly spaced along one side of the frame 16 for cooperatively receiving corresponding sprags 24. The slots 26 extend into the cavities 22 to enable the spring elements 28 to bias the sprags 24. The spring elements in one embodiment are compression springs. The dimensions of the frame 16 are such that an inner side 38 comes in sliding contact with the inner ring 12 and outer side 40 comes in sliding contact with the outer ring 14, when provided in the space between the inner and the outer rings (best shown in FIG. 2). The frame 16 along with the sprags 24 and the roller elements 20 enable the inner ring and the outer ring 14 to rotate relative to each other in one direction, as discussed in more detail below.

Referring to FIG. 5, the posts 32 projecting from the flat side surface of the retaining plate 34 are configured to be inserted into the plurality of corresponding holes on the frame 16. The retaining plate 34 also includes a plurality of feet 42, each of which is configured to be inserted into a corresponding slot 26 on the frame 16. The feet 42 maintain the position of the spring elements 28 in the slots 26, so that the spring elements bias against the corresponding sprags 24 as shown in FIG. 4. The feet 42 also prevent the spring elements 26 from coming out of the slots 26. The retaining ring 34 is made of nylon 66 in one embodiment.

As shown in FIG. 6, the plurality of sockets 18 for holding the roller elements 20 are formed on the opposite side of the frame 16 from the cavities 22 for housing the sprags 24. The thickness of the frame 16 is such that it enables the roller elements 20 to extend beyond the inner side 38 and the outer side 40 of the frame 16 and enable the roller elements 20 to come in contact with the inner and the outer rings 12, 14 (best shown in FIG. 3).

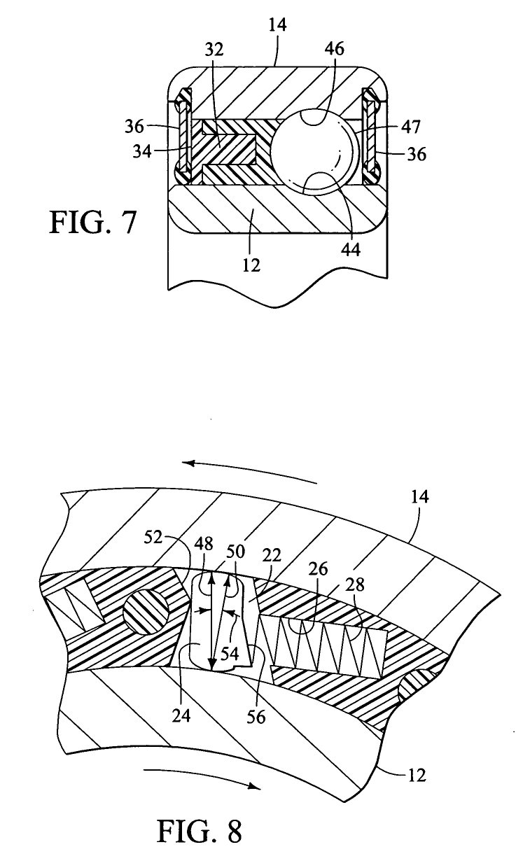

Turning to FIG. 7, a sectional view of the bearing assembly 10 shows that the inner ring 12 and the outer ring 12 both include a raceway 44 and 46, which face each other to cooperatively form an annular channel 47 between the two raceways. The channel 47 enables the roller elements 20 to rotate within the channel and perform their functions as bearings, i.e., allow relative rotation between the inner ring 12 and the outer ring 14. The roller elements 20 in one embodiment are steel balls. However, they may also come in other forms such as cylindrical rollers, for example, in which case, the sockets 18 of the frame 16 would have to be reconfigured to modify a cylindrical roller element 20 rather than a ball. The sockets 18 are spaced relatively evenly on the frame 16. In one embodiment of the invention, the frame 16 is formed from nylon 66. However, other relatively rigid material may also be employed.

In operation, the unidirectional bearing assembly 10 is configured to rotate in only one relative direction. In other words, the inner ring 12 rotates in only one direction relative to the outer ring 14, and the outer ring rotates in only one direction relative to the inner ring. As shown in FIG. 8, the outer ring 14 is allowed to rotate freely in the counterclockwise direction relative to the inner ring 12, when the inner ring is held stationary, but is prevented by the sprags 24 from rotating in the clockwise direction relative to the inner ring. Similarly, the bearing assembly 10 is configured such that the inner ring 12 rotates freely in the clockwise direction relative to the outer ring 14, when the outer ring is held stationary, but is prevented by the sprags 24 from rotating in the clockwise direction relative to the outer ring.

In accordance with the present invention, the unidirectional characteristics of the bearing assembly 10 lie on the dimensions of the wedges or sprags 24. The longest distance of the sprags 24 is slightly greater (as shown by arrow 48) than the radial distance between the inner ring 12 and the outer ring 14 (as shown by arrow 50). Thus, the sprags 24 are positioned at a slight tilt within the cavity 22. In other words, the arrow 48 is at a slight angle relative to the arrow 50. The sprags 24 are maintained in that position by the spring elements 28 in conjunction with a pivot point 52 which projects within the cavity 22 on the side opposite the slots 26.

When the inner ring 12 is connected to a load and a rotating force is applied to the outer ring 14 in the counterclockwise direction, i.e., in the direction of the tilt of the sprags 24. The friction between the sprags 22 and outer ring 14 and the inner ring 12 is minimal. As a result, the outer ring 14 is allowed to rotate in the counterclockwise direction relative to the inner ring 12, which is kept stationary by the load.

On the other hand, when a force is applied to the outer ring 14 in the clockwise direction relative to the inner ring 12, i.e., in the opposite direction of the tilt of the sprags 24, because the longest distance 48 of the sprags is longer than the radial distance (arrow 50) between the inner and the outer rings 12, 14, the sprags 24 act as a brake or wedge to prevent the outer ring 14 from rotating in the clockwise direction relative to the inner ring. If the force applied to the outer ring 14 is greater than the load keeping the inner ring 12 stationary, then the entire assembly 10 will rotate in the clockwise direction, overcoming the load. However, the outer ring 14 does not rotate in the clockwise direction relative to the inner ring 12.

Similarly, when the outer ring 14 is connected to a load and a force is applied to the inner ring 12 in the clockwise direction relative to the outer ring, i.e., in the direction of the tilt of the sprags 24, the inner ring 12 is allowed to rotate in the clockwise direction. By contrast, when a force is applied to the inner ring 12 in the counterclockwise direction relative to the stationary outer ring 14, i.e., in the direction opposite the tilt of the sprags 24, the sprags act again as a brake or a wedge, to prevent the inner ring 12 from rotating in the counterclockwise direction.

In one embodiment of the invention, each of the sprags 24 includes a ledge 56 on the side facing the spring element 26 (best shown in FIG. 8). The ledge 56 is configured to be in constant contact with the spring element 28. In this manner, even when the sprag 24 wears during the normal course of operation, it is constantly maintained in the intended tilt position by the spring element 28, in cooperation with the pivot point 52. This arrangement helps to reduce play in the sprags 24 within the cavities, thereby preventing the sprags from flipping in the direction opposite the tilt and causing a catastrophic failure. In other words, the sprags 24 are prevented from flipping to an angle in the clockwise direction relative to the arrow 50 (see FIG. 8). The pivots 52 assist the spring elements 28 in maintaining the proper positioning of the sprags 24.

While various embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

What is claimed is:

1. A unidirectional bearing apparatus comprising:
an inner ring;
an outer ring concentric with and spaced from said inner ring; and
an annular frame configured to be provided between said inner ring and the outer ring;
said frame having a first side including a plurality of sockets for holding a plurality of roller elements, and a second side opposite said first side including a plurality of cavities, each housing a corresponding brake element, said second side further including a plurality of slots each extending into a corresponding one of said cavities and holding spring elements for maintaining said brake elements in a predetermined position within said cavities;
wherein said brake elements and said spring elements cooperatively enable relative rotation between said inner ring and said outer ring in one direction.

2. The apparatus as defined in claim 1, wherein said frame is a single-piece structure.

3. The apparatus as defined in claim 1, wherein said brake element is longer than a radial distance between said inner ring and said outer ring, and is positioned at an angle so as to fit between said inner ring and said outer ring.

4. The apparatus as defined in claim 3, wherein said cavities each include a pivot formed opposite said corresponding slot for enabling said brake element to tilt about said pivot in cooperation with said spring element.

5. The apparatus as defined in claim 4, wherein said sprag includes a ledge on a side facing said spring element, said ledge being configured to enable said spring element to bias said brake at said foot.

6. The apparatus as defined in claim 1, further comprising retaining plate for holding said spring means and said brake element in their respective slots and cavities.

7. The apparatus as defined in claim 6, wherein said retaining plate includes a plurality of feet configured to be matingly received by the slots in said frame.

8. The apparatus as defined in claim 6, wherein said retaining plate includes a plurality of posts configured to be inserted into corresponding holes formed on said second side of said frame.

9. The apparatus as defined in claim 1, wherein said spring elements comprise compression springs.

10. The apparatus as defined in claim 1, wherein said brake elements comprise sprags or wedges.

11. The apparatus as defined in claim 1, wherein said roller elements comprise balls.

12. The apparatus as defined in claim 1, further comprising a seal provided on said first side and said second side of said frame between said first ring and said second ring.

13. A frame apparatus configured to be provided between an inner ring and an outer ring of a unidirectional bearing assembly, said apparatus comprising:
a first side including a plurality of sockets for holding a plurality of roller elements; and
a second side opposite said first side including a plurality of cavities each for housing a brake element, and a plurality of slots, each configured to extend into a corresponding one of said cavities and holding spring elements for maintaining said brake elements in a predetermined position within said cavities;
wherein said brake elements and said spring elements cooperatively enable relative rotation between the inner ring and the outer ring in one direction.

14. The apparatus as defined in claim 13, wherein said frame is a single-piece structure.

15. The apparatus as defined in claim 13, wherein said brake element is longer than a radial distance between the inner ring and the outer ring, and is positioned at an angle so as to fit between the inner ring and the outer ring.

16. The apparatus as defined in claim 15, wherein said cavities each include a pivot formed opposite said corresponding slot for enabling said brake element to tilt about said pivot in cooperation with said spring element.

17. The apparatus as defined in claim 16, wherein each of said brake elements includes a ledge on a side facing said corresponding spring element, said ledge being configured to enable said spring element to bias said brake element at said ledge.

18. The apparatus as defined in claim 13, further comprising retaining plate for holding said spring elements and said brake elements in their respective slots and cavities.

19. The apparatus as defined in claim 18, wherein said retaining plate include a plurality of projection configured to be matingly received by the slots in said frame.

20. The apparatus as defined in claim 18, wherein said retaining plate includes a plurality of posts configured to be inserted into corresponding holes formed on said second side of said frame.

21. The apparatus as defined in claim 13, wherein said spring elements comprise compression springs and said roller elements comprise balls.

22. The apparatus as defined in claim 13, wherein said brake elements comprise sprags or wedges.
